(19) United States
(12) Patent Application Publication
(10) Pub. No.: US 2024/0256410 A1
(43) Pub. Date: Aug. 1, 2024

(54) INFORMATION PROCESSING SYSTEM AND INFORMATION PROCESSING METHOD

(71) Applicant: Hitachi, Ltd., Tokyo (JP)

(72) Inventors: Kenta SATO, Tokyo (JP); Tsukasa SHIBAYAMA, Tokyo (JP); Akira DEGUCHI, Tokyo (JP)

(73) Assignee: Hitachi, Ltd., Tokyo (JP)

(21) Appl. No.: 18/461,719

(22) Filed: Sep. 6, 2023

(30) Foreign Application Priority Data
Jan. 30, 2023 (JP) 2023-012178

(51) Int. Cl. G06F 11/20; G06F 9/50; G06F 11/14

(52) U.S. Cl. CPC G06F 11/2092; G06F 9/5016; G06F 11/1464

(57) ABSTRACT

An information processing system includes storage apparatuses installed in areas, SDSs provided on a cloud, and a management system. The management system estimates, in reference to configuration information and performance information regarding a volume of each of the storage apparatuses, a required resource amount required to fail over the volume of each storage apparatus to a duplicate volume. The management system selects an SDS of a replication destination in such a manner as to minimize a required resource amount aggregated for each installation location and for each storage system SDS, while locating in a distributed manner, in the SDSs, duplicate volumes related to the storage apparatuses located at an identical point.

### BACKGROUND OF THE INVENTION

### 1. Field of the Invention

The present invention relates to an information processing system and an information processing method.

### 2. Description of the Related Art

In disaster recovery (DR), an active system and a standby system are located in different areas, and when a disaster such as an earthquake occurs, the standby system takes over business processing from the active system. There has recently been growing interest in Disaster Recovery as a Service (DRaaS) in which cloud-based DR is provided to an on-premise system. For example, a software defined storage (SDS) disclosed in Japanese Patent Laid-open No. 2019-101703 can be used as a storage on the cloud to provide DR to an on-premise system.

### SUMMARY OF THE INVENTION

When the DRaaS is provided, efficient operation of the SDS on the cloud is heavily involved in reduction of operational costs of the DRaaS. At normal times, the SDS in the DRaaS requires only input/output (IO) processing for backup, leading to small IO loads. On the other hand, when a defect occurs on the on-premise system side, IO processing is required for a failed-over application, leading to a rapid increase in IO loads.

In the SDS, to shorten a failover time (recovery time (recovery time object (RTO))) with respect to an IO load of a failover, surplus computational resources are desirably secured in advance to provide for a failover rather than performing scale-out of the SDS such as rebalance processing, which requires much time. However, securing of surplus computational resources accounts for the operational cost of the SDS, leading to an increased operational cost of the DRaaS.

In view of the above-described circumstances, an object of the present invention is to provide an information processing system and an information processing method that reduce the surplus computational resources for the SDS used to provide for a failover and reduce the operational cost of the DRaaS.

To solve the above-described problem, an aspect of the present invention provides an information processing system including a plurality of storage apparatuses installed in a plurality of areas, a plurality of storage systems including a plurality of storage nodes provided on a cloud, and a management system, in which a processor of the management system acquires, from each of the plurality of storage apparatuses, configuration information and performance information regarding volumes of the plurality of storage apparatuses, estimates, in reference to the configuration information and the performance information, a required resource amount for replication in the storage system that is required when a duplicate volume to which a volume of each of the plurality of storage apparatuses is to be failed over is created in the storage system and a required resource amount for failover in the storage system that is required when the volume is failed over to the duplicate volume, divides, according to an installation location, the plurality of storage apparatuses into installation location groups of the storage apparatuses, the storage apparatuses possibly simultaneously becoming defective, aggregates, for each of the installation location groups and for each of the storage systems, the required resource amount for replication and the required resource amount for failover related to the volume of each of the storage apparatuses, selects, as the storage system of a replication destination in which the duplicate volume is to be created, the storage system in such a manner as to minimize the required resource amount for failover aggregated for each of the installation location groups and for each of the storage systems, while locating in a distributed manner, in the plurality of storage systems, the duplicate volume related to the plurality of storage apparatuses located at an identical point, and implements, on the selected storage system of the replication destination, replication in which the duplicate volume is created.

According to the present invention, surplus computational resources for the SDS used to provide for a failover can be reduced to decrease the operational cost of the DRaaS.

### BRIEF DESCRIPTION OF DRAWINGS

FIG. 1 is a diagram depicting a configuration of an information processing system according to Embodiment 1;

FIG. 2 is a diagram depicting a hardware configuration of the information processing system according to Embodiment 1;

FIG. 3 is a diagram depicting a configuration of a memory of a storage apparatus according to Embodiment 1;

FIG. 4 is a diagram depicting a configuration of a memory of a storage node according to Embodiment 1;

FIG. 5 is a diagram depicting a configuration of a memory of a DR managing system according to Embodiment 1;

FIG. 6 is a diagram depicting volume configuration information according to Embodiment 1;

FIG. 7 is a diagram depicting replication configuration information according to Embodiment 1;

FIG. 8 is a diagram depicting storage node configuration information according to Embodiment 1;

FIG. 9 is a diagram depicting volume performance information according to Embodiment 1;

FIG. 10 is a diagram depicting storage node performance information according to Embodiment 1;

FIG. 11 is a diagram depicting storage apparatus management information according to Embodiment 1;

FIG. 12 is a diagram depicting SDS management information according to Embodiment 1;

FIG. 13 is a diagram depicting replication management information according to Embodiment 1;

FIG. 14 is a diagram depicting required resource management information according to Embodiment 1;

FIG. 15 is a flowchart depicting processing for newly registering a storage apparatus in a DR managing system according to Embodiment 1;

FIG. 16 is a flowchart depicting processing for newly registering a DR target volume according to Embodiment 1;

FIG. 17 is a flowchart depicting replication destination SDS selecting processing according to Embodiment 1;

FIG. 18 is a flowchart depicting replication construction preparing processing according to Embodiment 1;

FIG. 19 is a flowchart depicting failover processing for a defective volume according to Embodiment 1;

FIG. 20 is a flowchart depicting failback processing for a defective volume according to Embodiment 1;

FIG. 21 is a diagram depicting a configuration of an information processing system according to Embodiment 2;

FIG. 22 is a diagram depicting SDS installation location management information according to Embodiment 2;

FIG. 23 is a diagram depicting SDS management information according to Embodiment 2; and

FIG. 24 is a flowchart depicting replication destination SDS selecting processing according to Embodiment 2.

### DESCRIPTION OF THE PREFERRED EMBODIMENTS

Embodiments of the present invention will be described below in detail with reference to the drawings. The descriptions and drawings below are illustrative for describing the present invention and are subjected to appropriate omission and simplification for clarification of description. Further, not all the combinations of features described in the embodiments are essential for the solution of the invention. The present invention is not limited to the embodiments, and all applied examples conforming to the concepts of the present invention are included in the technical scope of the present invention. Those who are skilled in the art can make various additions, modifications, and the like to the present invention within the scope of the invention. The present invention can be implemented in various other forms. Each component may be singular or plural unless otherwise noted.

In the description below, various pieces of information may be described below using such expressions as “tables,” “charts,” “lists,” and “ques,” but the various pieces of information may be expressed using any other data structure. To indicate independence from the data structures, an “XX table,” an “XX list,” or the like may be referred to as “XX information.” In describing the content of each piece of information, such expressions as “identification information,” an “identifier,” a “name,” an “ID,” and a “number” are used and are interchangeable.

Further, in the description below, in a case where homogeneous elements are described without being distinguished from one other, reference numerals or common numbers in the reference numerals may be used. In a case where homogeneous elements are described while being distinguished from one other, reference numerals for the elements may be used or identifications (IDs) assigned to the elements may be used instead of the reference numerals.

Further, in the description below, there may be described processing that is carried out by execution of a program. When executed by at least one processor (for example, a central processing unit (CPU)), the program performs specified processing using a storage resource (for example, a memory), an interface device (for example, a communication port), and/or the like as appropriate. Accordingly, the subject of the processing may be the processor. Similarly, the subject of the processing performed by execution of the program may be a controller including a processor, an apparatus, a system, a computer, a node, a storage system, a storage apparatus, a server, a managing computer, a client, or a host. The subject of the processing performed by execution of the program (for example, the processor) may include a hardware circuit performing a part or all of the processing. For example, the subject of the processing performed by execution of the program may include a hardware circuit performing encryption and decryption, or compression and decompression. The processor operates as functional sections operating in accordance with the program to implement predetermined functions. The apparatus and the system including the processor are an apparatus and a system including the functional sections.

The program may be installed from a program source into an apparatus such as a computer. The program source may be, for example, a program distributing server or a storage medium that can be read by a computer. In a case where the program source is a program distributing server, the program distributing server includes a processor (for example, a CPU) and a storage resource, and the storage resource may further store a distributing program and a program to be distributed. Further, by executing the distributing program, a processor of the program distributing server may distribute, to another computer, the program to be distributed. Further, in the description below, two or more programs may be implemented as one program, or one program may be implemented as two or more programs.

### Embodiment 1

### (Configuration of Information Processing System 1S According to Embodiment 1)

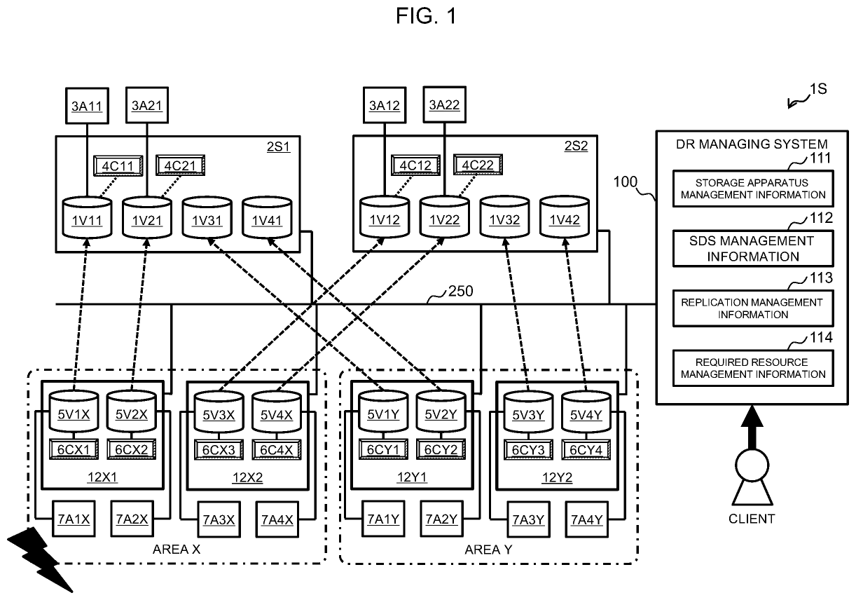

FIG. 1 is a diagram depicting a configuration of an information processing system 1S according to Embodiment 1. The information processing system 1S includes storage apparatuses 12Rx (12X1, 12X2, 12Y1, and 12Y2), SDSs 2Sy (2S1 and 2S2), and a DR managing system 100. The storage apparatuses 12Rx (R=X, Y, x=1, 2), SDSs 2Sy (y=1, 2), and the DR managing system 100 constitute a DR system constructed on a cloud by a provider of a DRaaS.

In the information processing system 1S, a plurality of storage apparatuses 12Rx of a plurality of clients are located in areas X and Y that are remote from each other and that would not be simultaneously affected by a disaster. The storage apparatuses 12X1 and 12X2 are operated by data centers in the area X managed by different clients. The storage apparatuses 12Y1 and 12Y2 are operated by data centers in the area Y managed by different clients.

In the information processing system 1S, pieces of data stored in volumes 5VαR (5V1X, 5V2X, 5V3X, 5V4X, 5V1Y, 5V2Y, 5V3Y, and 5V4Y) of the client-managed storage apparatuses 12Rx are replicated (duplicated) in the SDSs 2Sy in advance.

In the information processing system 1S, when a defect occurs in the storage apparatus 12Rx, IO processing executed on the volume 5VαR is failed over to the volume 1Vβy (1V11, 1V12, 1V31, or 1V41) of any of the SDSs 2Sy corresponding to a replication destination.

The storage apparatus 12X1 includes CPUs 6CX1 and 6CX2 and volumes 5V1X and 5V2X on which the CPUs 6CX1 and 6CX2 process IO from applications 7A1X and 7A2X. Similarly, the storage apparatus 12X2 includes CPUs 6CX3 and 6CX4 and volumes 5V3X and 5V4X on which the CPUs 6CX3 and 6CX4 process IO from applications 7A3X and 7A4X.

The storage apparatus 12Y1 includes CPUs 6CY1 and 6CY2 and volumes 5V1Y and 5V2Y on which the CPUs 6CY1 and 6CY2 process IO from applications 7A1Y and 7A2Y. Similarly, the storage apparatus 12Y2 includes CPUs 6CY3 and 6CY4 and volumes 5V3Y and 5V4Y on which the CPUs 6CY3 and 6CY4 process IO from applications 7A3Y and 7A4Y.

The SDSs 2Sy constitute an SDS cluster on the cloud. The SDS 2Sy is connected to the storage apparatus 12Rx via a network 250, and constructs a replication of the volume 5VαR of the storage apparatus 12Rx.

The SDS 2S1 includes CPUs 4C11 and 4C21 and volumes 1V11, 1V21, 1V31, and 1V41 on which the CPUs 4C11 and 4C21 execute IO processing. The volumes 1V11, 1V21, 1V31, and 1V41 respectively include replications of the volumes 5V1X, 5V2X, 5V3X, and 5V4X constructed in advance.

The SDS 2S2 includes CPUs 4C12 and 4C22 and volumes 1V12, 1V22, 1V32, and 1V42 in which the CPUs 4C12 and 4C22 execute IO processing. The volumes 1V12, 1V22, 1V32, and 1V42 respectively include replications of the volumes 5V1Y, 5V2Y, 5V3Y, and 5V4Y constructed in advance.

The SDS 2S1 includes the minimum number of CPUs that can execute IO processing on the volumes 5V1X and 5V2X in the area X or the volumes 5V1Y and 5V2Y in the area Y that may be subjected to a failover at a time due to a disaster. Similarly, the SDS 2S2 includes the minimum number of CPUs that can execute IO processing on the volumes 5V3X and 5V4X in the area X or the volumes 5V3Y and 5V4Y in the area Y that may be subjected to a failover at a time due to a disaster.

In FIG. 1, the SDS 2S1 and the SDS 2S2 fail over the two respective volumes at the same time, and thus, the two CPUs 4C11 and 4C21 are provided for the two volumes. However, the volumes and the CPUs that execute IO processing on the volumes are not limited to a one-to-one correspondence, and the number of CPUs provided for the volumes varies. Further, the subject of the IO processing on the volumes is not limited to the CPU, and may be any other computational resource such as a thread or a virtual CPU.

In the example in FIG. 1, the storage apparatus 12X1 and storage apparatus 12X2 located in the area X are simultaneously affected and failed over during a disaster. To prevent IO processing loads from concentrating on the failover destination SDS 2Sy, the volumes 5V1X and 5V2X in the storage apparatus 12X1 are respectively failed over to the volumes 1V11 and 1V21 in the SDS 2S1. Further, the volumes 5V3X and 5V4X in the storage apparatus 12X2 are respectively failed over to the volumes 1V12 and 1V22 in the SDS 2S2.

Similarly, the storage apparatus 12Y1 and storage apparatus 12Y2 located in the area Y are simultaneously affected and failed over during a disaster. To prevent IO processing loads from concentrating on the failover destination SDS 2Sy, the volumes 5V1Y and 5V2Y in the storage apparatus 12Y1 are respectively failed over to the volumes 1V31 and 1V41 in the SDS 2S1. Further, the volumes 5V3Y and 5V4Y in the storage apparatus 12Y2 are respectively failed over to the volumes 1V32 and 1V42 in the SDS 2S2.

As described above, the DR system is constructed in such a manner that the volumes 5V1X and 5V2X in the storage apparatus 12X1 and the volumes 5V3X and 5V4X in the storage apparatus 12X1 are respectively failed over to the SDS 2S1 and the SDS 2S2. Similarly, the DR system is constructed in such a manner that the volumes 5V1Y and 5V2Y in the storage apparatus 12Y1 and the volumes 5V3Y and 5V4Y in the storage apparatus 12Y2 are respectively failed over to the SDS 2S1 and the SDS 2S2.

In the example in FIG. 1, in a case where the area X is affected by a disaster, the volumes 1V11 and 1V21 in the SDS 2S1 process IO from applications 3A11 and 3A21 to take over, from the applications 7A1X and 7A2X, IO processing executed on the volumes 5V1X and 5V2X. Further, in a case where the area X is affected by a disaster, the volumes 1V12 and 1V22 in the SDS 2S2 process IO from applications 3A12 and 3A22 to take over, from the applications 7A3X and 7A4X, IO processing executed on the volumes 5V3X and 5V4X.

The DR managing system 100 is communicably connected to the storage apparatuses 12Rx and the SDSs 2Sy via the network 250. The DR managing system 100 receives a DR configuration construction indication (DRaaS contract entry), a failover execution indication, or the like from a DRaaS user and performs, on the storage apparatuses 12Rx and the SDSs 2Sy, operation related to the indication.

In addition to computational resources for the CPU and memory, the DR managing system 100 stores various kinds of information including storage apparatus management information 111, SDS management information 112, replication management information 113, and required resource management information 114 in predetermined storage regions. The DR managing system 100 executes various types of processing in reference to the indication input by the DRaaS user via a terminal (not illustrated). Description will be given below of the various types of processing, the storage apparatus management information 111, the SDS management information 112, the replication management information 113, and the required resource management information 114.

### (Hardware Configuration of Information Processing System 1S According to Embodiment 1)

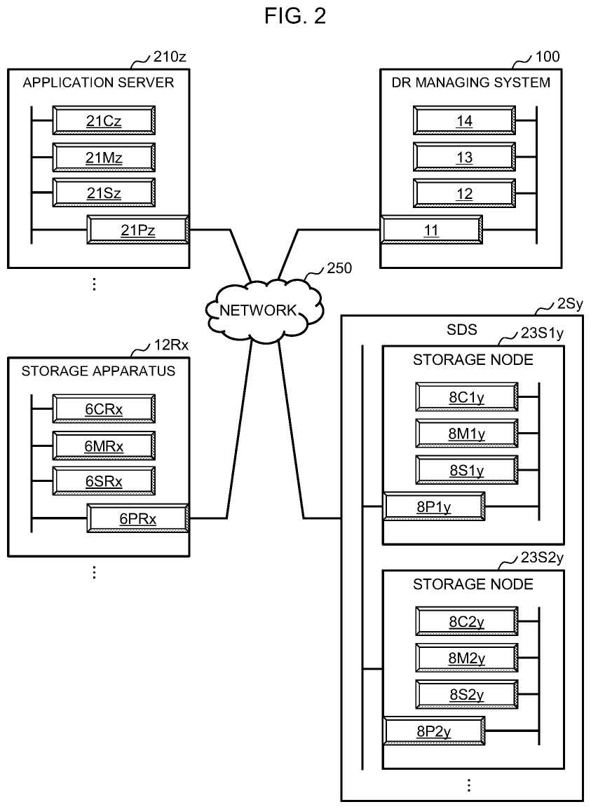

FIG. 2 is a diagram depicting a hardware configuration of an information processing system 1S according to Embodiment 1.

In the DR managing system 100, the storage apparatuses 12Rz, . . . , the SDSs 2Sy, . . . , and application servers 210z, . . . , and the processor and memory mounted in each of the apparatuses cooperate with each other in executing various types of processing while communicating via a communication port and the network 250.

The network 250 includes a plurality of types or systems (Ethernet (registered trademark), InfiniBand (registered trademark), and the like), and includes network equipment such as switches and routers. The network 250 may be a Virtual Private Network (VPN) or a virtual network using virtual switches and the like. The connection relation in the network 250 is illustrative, and there may be a network that is exclusively used among specific components. For example, a dedicated storage network (Fiber Channel or the like) may connect the storage apparatuses 12Rx and the application servers 210z.

The DR managing system 100 includes a CPU 14, a memory 13, a storage device 12, and a communication port 11.

The SDS 2Sy depicts a hardware configuration of each of the SDS 2S1 and the SDS 2S2 (FIG. 1). The SDS 2Sy is a storage cluster including a plurality of storage nodes 23Sγy (23S1y, 23S2y, . . . ). Each of the storage nodes 23Sγy (γ=1, 2, . . . , y=1, 2) includes a CPU 8Cγy, a memory 8Mγy, a storage device 8Sγy, and a communication port 8Pγy that are connected together via a bus.

The application server 210z depicts a hardware configuration of a server in which applications 7A (7A1X, 7A2X, 7A3X, 7A4X, 7A2Y, 7A3Y, and 7A4Y) and 3A (3A11, 3A21, 3A12, and 3A22) (FIG. 1) operate. The application server 210z includes a CPU 21Cz, a memory 21Mz, a storage device 21Sz, and a communication port 21Pz that are connected together via a bus. The application server 210z is located both on a public cloud managed by the provider of the DRaaS and in a data center managed by a user of the DRaaS, or the like.

The storage apparatus 12Rx depicts a hardware configuration of each of the storage apparatuses 12X1, 12X2, 12Y1, and 12Y2 (FIG. 1). The storage apparatus 12Rx includes a CPU 6CRx, a memory 6MRx, a storage device 6SRx, and a communication port 6PRx that are connected together via a bus. The storage apparatus 12Rx is located in a data center managed by the user of the DRaaS, or the like.

Note that the DR managing system 100 and the SDS 2Sy are assumed to be located on the public cloud managed by the provider of the DRaaS but may be located on a private cloud that can communicate with the storage apparatus 12Rx.

The storage apparatuses 12Rx and the SDSs 2Sy are storages that provide the application operating on the application server 210z with a volume that is a logical storage region formed from storage devices 6SRx, 8S1y, and 8S2y mounted in the storage apparatuses 12Rx and the SDSs 2Sy. The storage includes a replication function to duplicate data of a volume between storages (for example, between the SDS 2Sy and the storage apparatus 12Rx).

Note that the SDS 2Sy is referred to as a storage system to be distinguished from the storage apparatus 12Rx, for the sake of convenience.

The SDS 2Sy is configured by clustering of a plurality of storage nodes 23Sγy (γ=1, 2, . . . ). The SDS 2Sy can deal with excess or deficiency of the storage capacity and data input/output performance (IO performance) by reducing or increasing the number of storage nodes constituting the SDS 2Sy.

At normal times, the application server 210z is located in the data center of the user of the DRaaS and writes and reads data to and from the storage apparatus 12Rx in the data center according to the processing of the application. During a disaster or the like, in a case where a failover occurs in the storage apparatus 12Rx, the application server 210z present on the public cloud takes over the processing of the application server 210z located in the data center of the user of the DRaaS. The application server 210z need not constantly be present and only needs to be present when a failover occurs (for example, the application server 210z is deployed when a failover occurs, and deleted after restoration).

Each of the apparatuses including the DR managing system 100, the storage apparatus 12Rx, the SDS 2Sy, and the application server 210z need not be one physical apparatus, and may be configured by a virtualization technology as exemplified by a virtual machine and a container. Alternatively, the apparatus may be included in one physical apparatus as a plurality of virtual apparatuses. In contrast, the apparatus may be virtually configured as one apparatus by clustering of a plurality of physical apparatuses. Further, the apparatuses may be present in physically remote positions (areas).

Besides a physical solid state drive (SSD) and a physical hard disk drive (HDD), the storage devices 12, 6SRx, 8Sγy, and 21Sz may be virtual storage devices provided by a cloud vender (for example, AWS (registered trademark), S3, Amazon EBS (registered trademark), and the like).

### (Configuration of Memory 6MRx of Storage Apparatus 12Rx According to Embodiment 1)

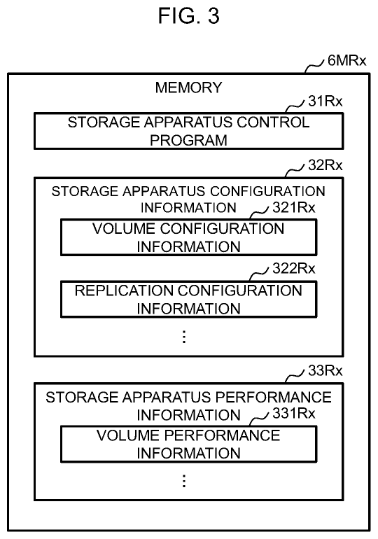

FIG. 3 is a diagram depicting a configuration of the memory 6MRx of the storage apparatus 12Rx according to Embodiment 1. The memory 6MRx of the storage apparatus 12Rx stores a storage apparatus control program 31Rx, storage apparatus configuration information 32Rx, and storage apparatus performance information 33Rx. The storage apparatus configuration information 32Rx includes volume configuration information 321Rx and replication configuration information 322Rx. The storage apparatus performance information 33Rx includes volume performance information 331Rx.

The storage apparatus control program 31Rx provides a volume 5VαR that is a logical storage region to the application 7A in reference to the storage apparatus configuration information 32Rx. The storage apparatus control program 31Rx includes a function of processing an IO request such as receiving an IO request issued by the application 7A to the volume 5VαR and writing or reading data to or from the storage device 6SRx.

Further, the storage apparatus control program 31Rx includes a function of replicating the data of the volume 5VαR into the storage apparatus 12Rx or the SDS 2Sy, according to the replication configuration information 322Rx.

Further, the storage apparatus control program 31Rx includes a function of recording statistical information such as IO Per Seconds (IOPS) or a response time, as storage apparatus performance information 33Rx. Further, the storage apparatus control program 31Rx includes a function of referencing and updating the storage apparatus configuration information 32Rx and a function of referencing the storage apparatus performance information 33Rx, according to a request from the DR managing system 100.

In addition to the above-described functions, the storage apparatus control program 31Rx may include general functions of storage systems such as thin provisioning, hierarchization of the storage devices 6SRx, snapshot, and compression and deduplication.

### (Configuration of Memory 8Mγy of Storage Node 23SγR According to Embodiment 1)

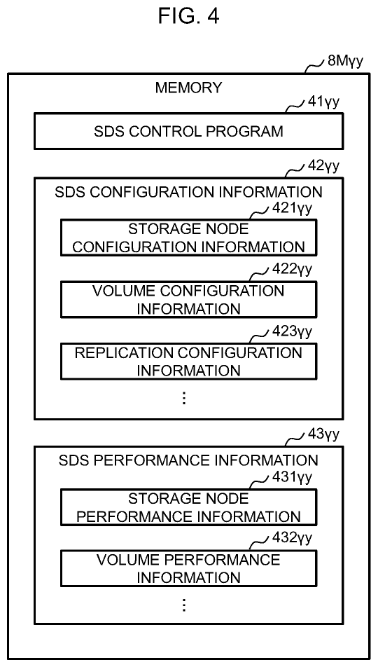

FIG. 4 is a diagram depicting a configuration of the 8Mγy of the storage node 23Sγy (γ=1, 2, . . . , y=1, 2) according to Embodiment 1. The memory 8Mγy of the storage node 23Sγy stores an SDS control program 41γy, SDS configuration information 42γy, and SDS performance information 43γy. The SDS configuration information 42γy includes storage node configuration information 421γy, volume configuration information 422γy, and replication configuration information 423γy. The SDS performance information 43γy includes storage node performance information 431γy and volume performance information 432□y.

The SDS configuration information 42γy and the SDS performance information 43γy are stored in the memory 8Mγy of each of the storage nodes 23Sγy constituting the SDS 2Sy. In reference to the SDS configuration information 42γy and the SDS performance information 43γy, information redundancy, consistency control, and the like are implemented.

The SDS control program 41γy provides a volume 1Vβy that is a logical storage region to the applications 3A (3A11, 3A12, 3A21, and 3A22) in reference to the SDS configuration information 42γy.

The SDS control program 41γy includes a function of processing an IO request such as receiving an IO request issued by the application 3A (3A11, 3A12, 3A21, or 3A22) to the volume 1VβR and writing or reading data to or from the storage device 8Sγy. Further, the SDS control program 41γy includes a function of allowing a plurality of storage nodes 23Sγy (23S1y, 23S2y, . . . ) to cooperate with one another in executing processing.

Further, the SDS control program 41γy includes a function of replicating the data of the volume 1Vβy into the storage apparatus 12Rx or the SDS 2Sy, according to the replication configuration information 423γy.

The SDS control program 41γy operating in any of the storage nodes 23Sγy constituting the SDS cluster is responsible for IO processing for the volume 1Vβy. When a defect occurs in a certain storage node 23Sγy, another storage node 23Sγy takes over the IO processing for the volume 1Vβy.

The SDS control program 41γy includes a function of recording, as SDS performance information 43γy, performance information related to the volume 1Vβy such as IOPS or a response time and performance information related to the storage node 23Sγy such as a CPU usage rate and a memory usage rate.

Further, the storage apparatus control program 41γy includes a function of referencing and updating the SDS configuration information 42γy and a function of referencing the SDS performance information 43γy, according to a request from the DR managing system 100. In addition, the storage apparatus control program 41γy includes a function of adding or deleting the storage node 23Sγy constituting the SDS 2Sy, according to a request from the DR managing system 100.

In addition to the above-described functions, the SDS control program 41γy may include general functions of storage systems such as thin provisioning, hierarchization of the storage devices 8Sγy, snapshot, compression and deduplication, and load distribution and rebalancing between the storage nodes 23Sγy.

### (Configuration of Memory 13 of DR Managing System 100 According to Embodiment 1)

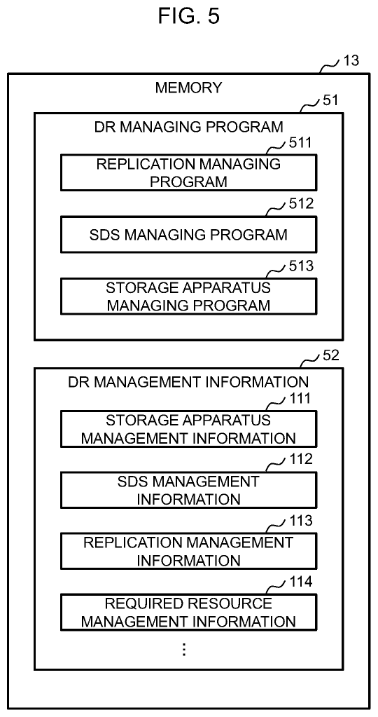

FIG. 5 is a diagram depicting a configuration of the memory 13 of the DR managing system 100 according to Embodiment 1. The memory 13 of the DR managing system 100 stores a DR managing program 51 and DR management information 52. The DR managing program 51 includes a replication managing program 511, an SDS managing program 512, and a storage apparatus managing program 513. The DR management information 52 includes the storage apparatus management information 111, the SDS management information 112, the replication management information 113, and the required resource management information 114.

The replication managing program 511 manages replication (DR configuration) using the storage apparatus 12Rx and the SDS 2Sy. Specifically, the replication managing program 511 indicates, for a certain DR target volume 5VαR, selection of the DR destination storage node 23Sγy (SDS 2Sy), construction of a replication for the storage apparatus 12Rx or the SDS 2Sy, and the like. Further, the replication managing program 511 indicates increase or decrease of the number of storage nodes 23Sγy installed in the SDS 2Sy according to the operating status of the SDS 2Sy.

Further, the replication managing program 511 performs DR failover processing, failback processing (processing for returning the IO processing for the volume 1Vβy to the volume 5VαR in the source storage apparatus 12Rx), and the like.

The SDS managing program 512 performs collection of information regarding the SDS 2Sy to be managed, reconfiguration based on an indication from the replication managing program 511, new construction of an SDS 2Sy, and the like.

The storage apparatus managing program 513 performs registration of the storage apparatus 12Rx under the control of the DR managing system 100, collection of information regarding the storage apparatus 12Rx, reconfiguration based on an indication from the replication managing program 511, and the like.

The storage apparatus management information 111 is management information regarding the configuration and state of the storage apparatus 12Rx under the control of the DR managing system 100. The storage apparatus management information 111 is referenced and updated by the replication managing program 511 and the storage apparatus managing program 513.

The SDS management information 112 is management information regarding the configuration and state of the SDS 2Sy under the control of the DR managing system 100. The SDS management information 112 is referenced and updated by the replication managing program 511 and the SDS managing program 512.

The replication management information 113 is management information for managing the relation between replications constructed between the storage apparatus 12Rx and the SDS 2Sy and the states of the replications. The replication management information 113 is referenced and updated by the replication managing program 511.

The required resource management information 114 is management information for managing resources required to operate the DRaaS. The required resource management information 114 is referenced and updated by the replication managing program 511.

Besides, configuration information and performance information may be stored on the memory 13, the information being related to the storage apparatus 12Rx and the SDS 2Sy and collected by the SDS managing program 512 and the storage apparatus managing program 513. Further, a program may be installed for providing a managing interface such as a graphical user interface (GUI) for clients using the DRaaS.

### (Volume Configuration Information 321Rx and 422γy According to Embodiment 1)

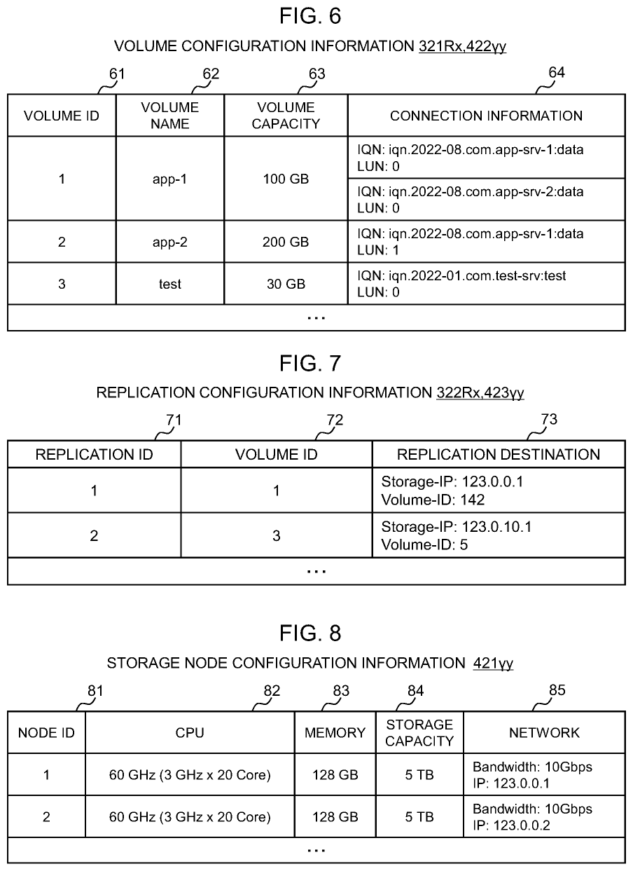

FIG. 6 is a diagram depicting pieces of volume configuration information 321Rx and 422γy according to Embodiment 1. The volume configuration information 321Rx indicates that that the volume 5VαR with a volume capacity 63 identified by a volume ID 61 and a volume name 62 is assigned to the application server 210z indicated in connection information 64. The volume configuration information 321Rx is set by the client through the DR managing system 100. This also applies to the volume configuration information 422γy. However, in a case where the client does not make a contract for the DRaaS or the volume has existed for some time before the contract, or in any other case, the volume configuration information 321Rx may be directly set by the client operating the storage apparatus 12Rx, without using the DR managing system 100.

### (Replication Configuration Information 322Rx and 423γy According to Embodiment 1)

FIG. 7 is a diagram depicting pieces of replication configuration information 322Rx and 423γy according to Embodiment 1. The replication configuration information 322Rx indicates that a replication of the volume 5VαR identified by a volume ID 72, the replication being identified by a replication ID 71, is configured in the volume 1Vβy in the SDS 2Sy depicted in the replication destination 73. This also applies to the replication configuration information 423γy.

Note that a replication is not necessarily created for the volume 5VαR indicated in the pieces of volume configuration information 321Rx and 422γy in FIG. 6. For example, for the volume 5VαR with a volume ID 61 of “2” in FIG. 6, there is no record that corresponds to the volume ID 72 in FIG. 7. That is, no replication is created for the volume ID 61.

### (Storage Node Configuration Information 421γy According to Embodiment 1)

FIG. 8 is a diagram depicting the storage node configuration information 421γy according to Embodiment 1. The storage node configuration information 421γy is a list of the storage nodes 23Sγy constituting the SDS 2Sy. The storage node configuration information 421γy indicates that the SDS 2Sy includes a storage node 23Sy with resources including a CPU 82, a memory 83, a storage capacity 84, and a network 85 that are identified by a node ID 81.

### (Volume Performance Information 331Rx and 432γx According to Embodiment 1)

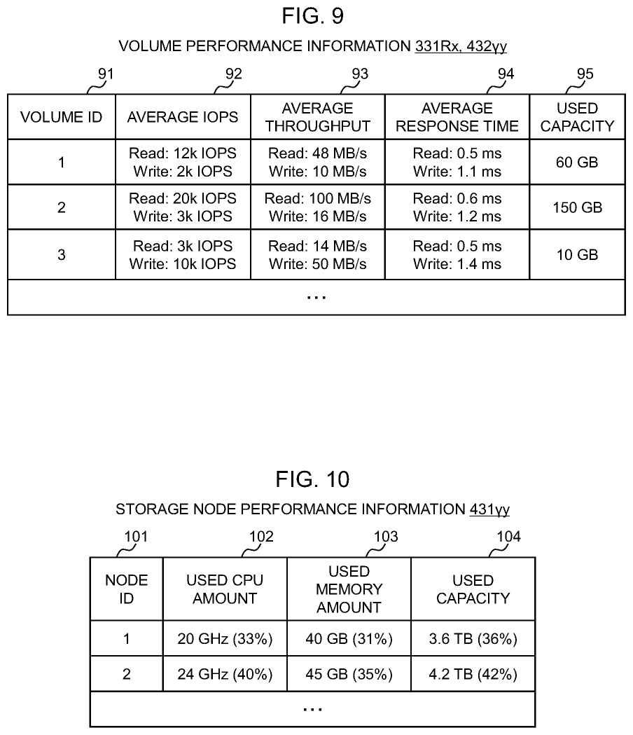

FIG. 9 is a diagram depicting pieces of volume performance information 331Rx and 432γx according to Embodiment 1. The volume performance information 331Rx indicates an average IOPS 92, an average throughput 93, an average response time 94, and a used capacity 95 for the volume 5VαR in the storage apparatus 12Rx identified by a volume ID 91. This also applies to the volume performance information 432γx. The volume performance information 331Rx is stored after the storage apparatus control program 31Rx and the SDS control program 41γy collects the operating statuses of the volumes 5VαR and 1Vβy under the control of the storage apparatus control program 31Rx and the SDS control program 41γy. This also applies to the volume performance information 432γx.

### (Storage Node Performance Information 431γy According to Embodiment 1)

FIG. 10 is a diagram depicting storage node performance information 431γy according to Embodiment 1. The storage node performance information 431γy indicates a used CPU amount 102, a used memory amount 103, the average response time 94, and the used capacity 95 for the storage node 23Sγy identified by a node ID 101. The storage node performance information 431γy is stored after the SDS control program 41γy and the SDS control program 41γy collects the operating status of the storage node 23Sγy under the control of the SDS control program 41□y.

### (Storage Apparatus Management Information 111 According to Embodiment 1)

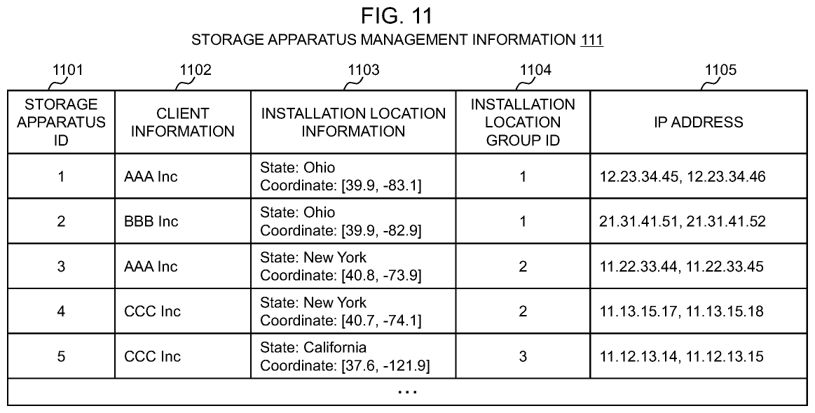

FIG. 11 is a diagram depicting storage apparatus management information 111 according to Embodiment 1. For the storage apparatus management information 111, the storage apparatus managing program 513 registers a new entry according to an indication for new registration of the storage apparatus 12Rx in the DR managing system 100, the indication being provided by the client using the DRaaS.

The storage apparatus management information 111 indicates client information 1102, installation location information 1103, an installation location group ID 1104, and an IP address 1105 for the storage apparatus 12Rx identified by a storage apparatus ID 1101.

The installation location information 1103 may include the installation location (address or the like) of the storage apparatus 12Rx, longitude and latitude information calculated from the installation location, and the like, and may include more detailed position information (a building, a server rack, a power supply system, and the like). The installation group ID 1004 is a group ID obtained by grouping (clustering) the storage apparatuses 12Rx that may be simultaneously affected by a defect due to the mutual proximity of the installation locations within a predetermined range.

### (SDS Management Information 112 According to Embodiment 1)

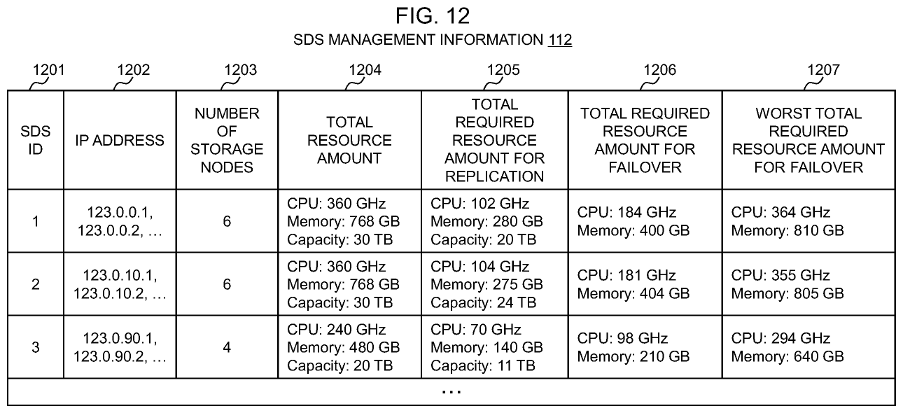

FIG. 12 is a diagram depicting SDS management information 112 according to Embodiment 1. For the SDS management information 112, the SDS managing program 512 registers a new entry according to an indication for new construction of the SDS 2Sy from the provider of the DRaaS.

The SDS management information 112 indicates an IP address 1202, the number of storage nodes 1203, a total resource amount 1204, a total required resource amount for replication 1205, a total required resource amount for failover 1206, and a worst total required resource amount for failover 1207 for the SDS 2Sy identified by an SDS ID 1201.

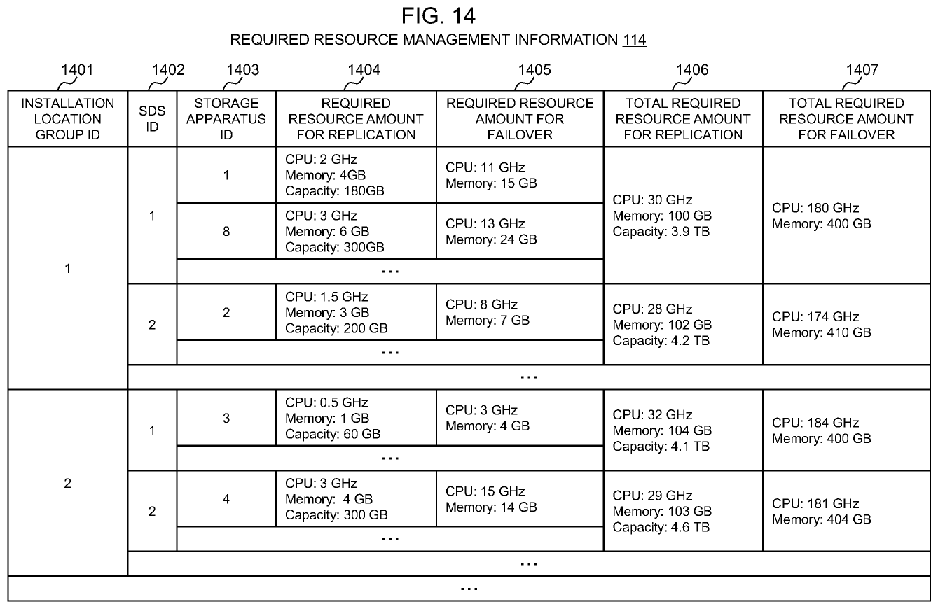

The total required resource amount for replication 1205 is a resource amount required to create a replication in the SDS 2Sy. The total required resource amount for replication 1205 is the total of the total required resource amounts for replication 1406 (FIG. 14) for each SDS ID 1402.

The total required resource amount for failover 1206 is a resource amount added to the total required resource amount for replication 1205 in order to provide for occurrence of a failover. However, the additional resource amount added to the storage capacity of the total required resource amount for replication 1205 is 0, that is, the storage capacity is invariable. The total required resource amount for failover 1206 is the maximum value of the total required resource amount for failover 1407 (FIG. 14) for each SDS ID 1402.

The worst total required resource amount for failover 1207 is the total of the total required resource amounts for failover 1407 (FIG. 14) for each SDS ID 1402, that is, the worst value obtained under the assumption that a failover occurs in all of the replications. The worst value may exceed the total required resource amount for the SDS 2Sy at that time because the SDS 2Sy is expanded as necessary.

### (Replication Management Information 113 According to Embodiment 1)

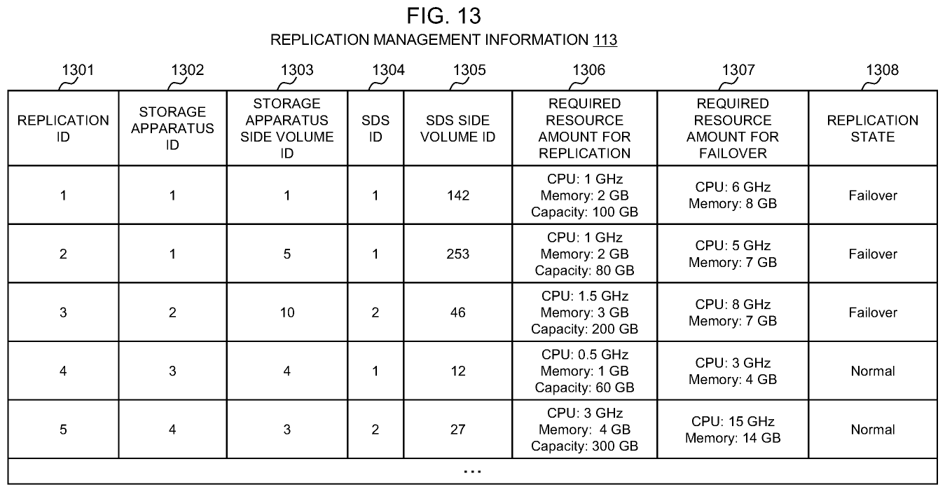

FIG. 13 is a diagram depicting replication management information 113 according to Embodiment 1. The replication management information 113 is information for managing a configuration of a replication between the volume 5VαR in the storage apparatus 12Rx and the volume 1Vβy in the SDS 2Sy. When a DR target volume 5V□R is added, a replication relation is pre-constructed between the volume 5VαR and the volume 1Vβy, and a new entry of the replication management information 113 is registered.

The replication management information 113 indicates a required resource amount for replication 1306, a required resource amount for failover 1307, and a replication state 1308 for a replication having a correspondence relation between a storage apparatus side volume ID 1303 of the storage apparatus ID 1302 identified by a replication ID 1301, an SDS ID 1304, and an SDS side volume ID 1305.

The replication ID 1301 may be an ID different from the replication ID 71 in FIG. 7. In this case, information is required to manage the replication ID inside the storage apparatus 12Rx.

The SDS ID 1304 involves a single duplication destination SDS 2Sy for a plurality of volumes 5VαR for one storage apparatus 12Rx. This allows the use of a function of replication with data consistency maintained by a plurality of volumes 5VαR (consistency group). However, the present embodiment is not limited to a single duplication destination SDS 2Sy, and a plurality of duplication destination SDSs 2Sy may be provided.

The required resource amount for replication 1306 is an estimated value for resources for the SDS 2Sy required for replication at normal times. The required resource amount for failover 1307 is an estimated value for resources for the SDS 2Sy required for IO processing for the application during a failover. Computational resources such as the CPU and the memory may vary between the required resource amount for replication 1306 and the required resource amount for failover 1307. However, the storage capacity is constant at the value of the required resource amount for replication 1306.

The replication state 1308 “Normal” indicates normal times, and “Failover” indicates the time of a failover. Although not depicted in the drawings, the replication management information 113 may include the elements constituting the SDS 12Sy, such as a network (communication port).

### (Required Resource Management Information 114 According to Embodiment 1)

FIG. 14 is a diagram depicting required resource management information 114 according to Embodiment 1. The required resource management information 114 is used to manage the resource amount required for DR on a per-installation location group basis. The required resource management information 114 is created by aggregating the pieces of information including the storage apparatus management information 111 (FIG. 11), the SDS management information 112 (FIG. 12), and the replication management information 113 (FIG. 13). A new entry is registered when a new installation location group is created at the time of new construction of an SDS 2Sy and at the time of addition of a DR target volume.

In the required resource management information 114, one SDS 2Sy is shared among a plurality of installation location groups. Further, one SDS 2Sy is responsible for replication of one storage apparatus 12Rx for data consistency.

The required resource management information 114 includes a required resource amount for replication 1404, a required resource amount for failover 1405, a total required resource amount for replication 1406, and a total required resource amount for failover 1407 that are managed on a per-installation location group ID 1401 basis, for each combination of the SDS ID 1402 and the storage apparatus ID 1403.

Besides, the required resource management information 114 includes information regarding the client using the DR managing system 100 (contract information, billing information, and the like), authentication information required for the client to access the DR managing system 100, information required for the DR managing system 100 to communicate with the storage apparatus 12Rx and the SDS 2Sy, account information regarding the public cloud (or private cloud) operating the SDS 2Sy, and the like.

### (Processing for Newly Registering Storage Apparatus 12Rx According to Embodiment 1)

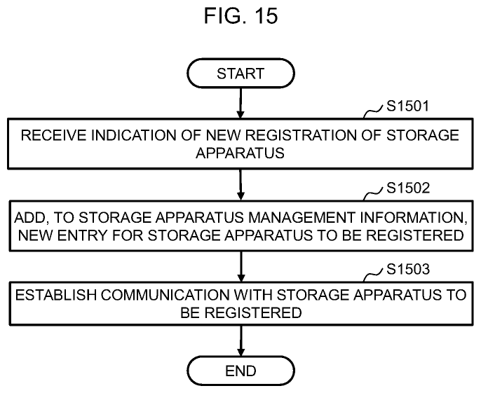

FIG. 15 is a flowchart depicting processing for newly registering the storage apparatus 12Rx in the DR managing system 100 according to Embodiment 1. The present new registration processing is executed by the storage apparatus managing program 513 when a client under contract for the DRaaS registers the storage apparatus 12Rx of the client in the DR managing system 100. The client specifies the installation location of the storage apparatus 12Rx when registering the storage apparatus 12Rx in the DR managing system 100.

First, in step S1501, the storage apparatus managing program 513 receives an indication, from the client, for new registration of the storage apparatus 12Rx in the DR managing system 100 (including the specification of the installation location of the storage apparatus 12Rx). In step S1501, the indication may include client information and connection information (Internet Protocol (IP) address, authentication information, and the like) required for the DR managing system 100 to communicate with the storage apparatus 12Rx, as necessary.

Then, in step S1502, the storage apparatus managing program 513 adds, to the storage apparatus management information 111, a new entry for the storage apparatus 12Rx to be registered.

Then, in step S1503, the storage apparatus managing program 513 establishes communication with the storage apparatus 12Rx to be registered in S1502. Execution of step S1503 allows the storage apparatus managing program 513 to communicate with the storage apparatus 12Rx for collecting configuration information and performance information and providing an indication for reconfiguration of the storage apparatus 12Rx.

### (Processing for Newly Registering DR Target Volume According to Embodiment 1)

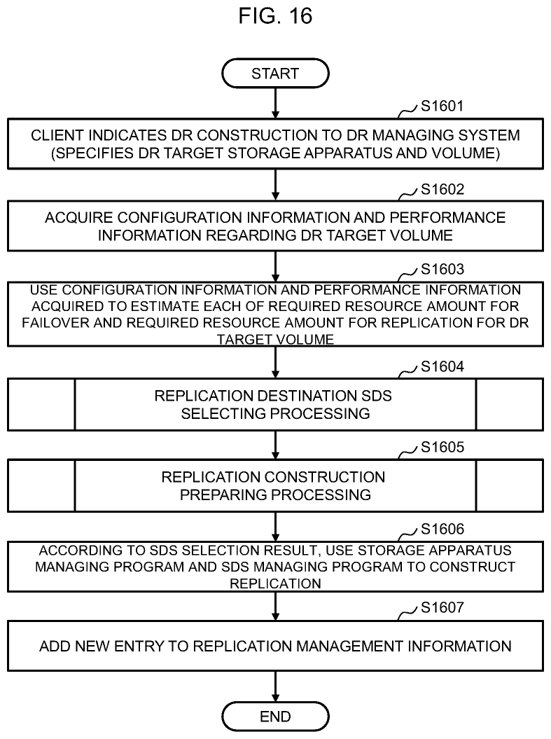

FIG. 16 is a flowchart depicting processing for newly registering a DR target volume according to Embodiment 1. The processing for newly registering a DR target volume is executed when a client under contract for the DRaaS newly registers a certain volume (storage apparatus 12Rx side) as a DR target volume in the DR managing system 100.

The present processing for newly registering a DR target volume is a part of processing executed by the replication managing program 511. When the present processing for newly registering a DR target volume is executed, the DR target storage apparatus 12Rx is assumed to be registered in the DR managing system 100 in advance (see FIG. 14).

Further, when the present processing for newly registering a DR target volume is executed, a DR source volume 5VαR on the storage apparatus 12Rx side is assumed to be already created by the client. A DR destination volume 1Vβy on the SDS 2Sy side is created by the present processing for newly registering a DR target volume.

First, in step S1601, the replication managing program 511 receives an indication from the client to the DR managing system 100 for DR construction (including the specification of the DR target storage apparatus 12Rx and volume 5VαR). Besides, a replication mode (synchronization/asynchronization of a replication pair) may be caused to be specified.

Then, in step S1602, the replication managing program 511 uses the storage apparatus managing program 513 to acquire configuration information and performance information regarding the DR target volume 5VαR.

Then, in step S1603, the replication managing program 511 uses the configuration information and performance information regarding the DR target volume 5VαR acquired in step S1602, to estimate each of the required resource amount for failover and the required resource amount for replication for the DR target volume 5VαR. That is, when the replication and IO processing at normal times are failed over to the SDS 2Sy, each of required resources (CPU, memory, capacity, and the like) for the SDS 2Sy is estimated.

Various methods can be used for estimation, but for example, 100% is assigned in advance to resources such as the capacity for which the required amount does not vary between before a failover and after the failover. For resources such as the CPU and the memory for which the required amount varies before a failover and after the failover, IO characteristics of the DR target volume 5VαR such as IOPS, throughput, and read/write ratio are estimated by application of predefined math formulae to the IO characteristics. The parameters of the math formulae may be subjected to automatic adjustment or the like based on actual performance achieved with the DR target volume 5VαR already registered in the DR managing system 100 (resource amount required when a failover actually occurred in the past).

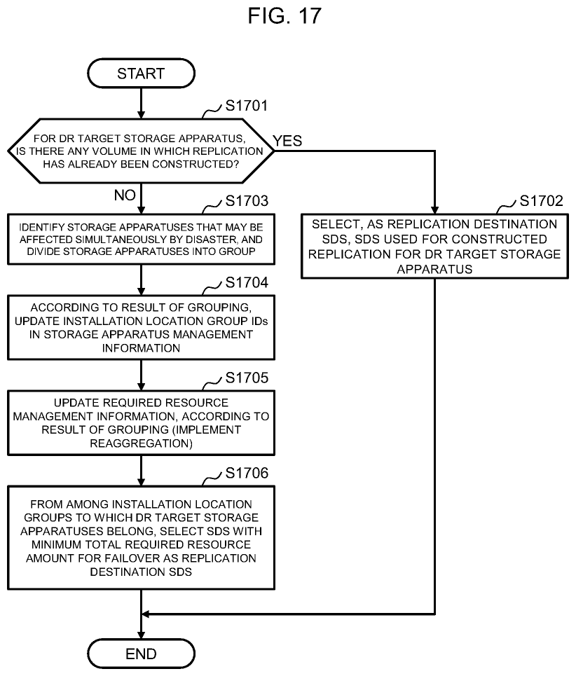

Next, in step S1604, the replication managing program 511 selects an appropriate SDS 2Sy as a replication destination for the DR target volume 5VαR. The details of step 1604 will be described below with reference to FIG. 17.

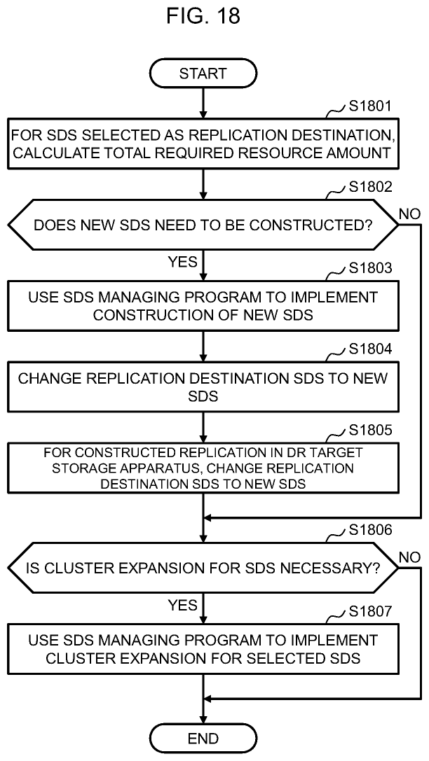

Then, in step S1605, the replication managing program 511 prepares for construction of a replication according to the result of selection of the SDS 2Sy in step S1604. The details of step 1605 will be described below with reference to FIG. 18.

Subsequently, in step S1606, the replication managing program 511 uses the storage apparatus managing program 513 and the SDS managing program 512 to construct a replication of the DR target volume 5VαR in the SDS 2Sy selected in step S1604. Step S1606 implements establishment of communication between the storage apparatus 12Rx and the SDS 2Sy, indication for construction of a replication relation between the storage apparatus 12Rx and the SDS 2Sy, update of various types of configuration information, addition of a new entry, creation of a volume in the replication destination, and the like.

Then, in step S1607, the replication managing program 511 adds a new entry to the replication management information 113.

Note that although not depicted in the drawings, there may be executed processing in which the required resource amount is periodically re-estimated for all the volumes 5VαR (that is, all the replications) in reference to the latest performance information, to change the replication destination SDS 2Sy. Further, the required resource amount may be re-estimated when the DR configuration is deleted (DR target volume is deleted) by indication given by the client.

### (Details of Processing for Selecting Replication Destination SDS According to Embodiment 1)

FIG. 17 is a flowchart depicting the details of replication destination SDS selecting processing according to Embodiment 1 (FIG. 16).

In the present replication destination SDS selecting processing, the replication destination SDS 2Sy is selected in such a manner as to distribute the replication destination SDSs 2Sy of the storage apparatuses 12Rx that belong to an identical installation location group and that may be simultaneously affected by a defect due to the mutual proximity of one another within a predetermined range. Thus, the replication destination SDS 2Sy is selected in such a manner that, when a disaster occurs in a certain area and a failover simultaneously occurs in a plurality of storage apparatuses 12Rx belonging to a certain installation location group, the failover imposes an even load on the SDSs 2Sy. That is, when a failover is performed at once on all the storage apparatuses 12Rx belonging to the identical installation location group, the failover increases the resource consumption in each SDS 2Sy by an even amount.

When a plurality of storage apparatuses 12Rx are divided into installation location groups, not only information regarding the installation location, but also information such as the required resource amount for each replication in each storage apparatus 12Rx may be taken into account. For example, preferably, the total required resource amount for failover 1407 for each installation location group ID 1401 in FIG. 14 is made even and approximately constant. This allows minimization of the required resource for the SDS 2Sy calculated in the replication construction preparing processing (FIG. 18).

First, in step S1701, the replication managing program 511 determines whether there is any volume 5VαR in which a replication is already constructed for the DR target storage apparatus 12Rx. The replication managing program 511 shifts the processing to step S1702 in a case where there is a volume 5VαR in which a replication is already constructed (step S1701 YES), and shifts the processing to step S1703 in a case where there is not a volume 5VαR in which a replication is already constructed (step S1701 NO).

In step S1702, the replication managing program 511 selects, as the replication destination SDS 2Sy, the SDS 2Sy used for the constructed replication for the DR target storage apparatus 12Rx.

In step S1703, the replication managing program 511 identifies and groups the storage apparatuses 12Rx that may be simultaneously affected by a disaster due to the mutual proximity of one another within the predetermined range. The grouping may be based on an address such as “State” in the installation location information or may use a clustering algorithm such as k-means based on coordinates (longitude and latitude). Further, the grouping takes into account not only the information regarding the installation location but also such information as the required resource amount for each replication in each storage apparatus 12Rx.

Next, in step S1704, the replication managing program 511 updates the installation location group ID 1104 in the storage apparatus management information 111, according to the result of grouping in installation location groups in step S1703. In step S1704, the installation location group ID 1104 in the storage apparatus management information 111 is updated, and the required resource amount is updated according to the assignment of the new installation location group.

Then, in step S1705, the replication managing program 511 reaggregates and updates the required resource management information 114, according to the result of grouping according to the installation location group in step S1703. Note that update of the installation location group does not change the correspondence relation between the SDSs 2Sy and the storage apparatuses 12Rx, preventing the SDS management information 112 from being updated.

Then, in step S1706, in the required resource management information 114 reaggregated in step S1705, the SDS 2Sy with the minimum total required resource amount for failover 1407 is selected from the SDSs 2Sy in the installation location group (installation location group ID 1401) to which the DR target storage apparatus 12Rx belongs, as the replication destination SDS 2Sy.

Note that, in step S1706, the replication managing program 511 locates in a distributed manner, in different SDSs 2Sy, duplicate volumes related to the storage apparatuses 12Rx located at an identical point, according to a replication relation between the storage apparatuses 12Rx and the SDS 2Sy defined in advance in the replication management information 113. The replication managing program 511 may dynamically construct the replication relation between the storage apparatuses 12Rx and the SDSs 2Sy in such a manner as to locate in a distributed manner, in the SDSs 2Sy, the duplicate volumes related to the storage apparatuses 12Rx at the identical point.

A selection algorithm for the replication destination SDS 2Sy in the present replication destination SDS selecting processing is an example in which the above-described idea is easily realized, and a more advanced algorithm may be used to select the replication destination SDS 2Sy. For example, with the above-described idea formulated as a constraint satisfaction problem or a mathematical programming problem, an existing optimization solver or the like may be used to find a solution.

In the present replication destination SDS selecting processing, a single SDS 2Sy is selected for all the volumes 5VαR in one storage apparatus 12Rx. This is intended to use a function of replication (consistency group) with consistency of data maintained among a plurality of volumes.

However, selecting a single SDS 2Sy for all the volumes 5VαR in one storage apparatus 12Rx is not essential, and different SDSs 2Sy may be assigned to the respective volumes 5VαR in a certain storage apparatus 12Rx. In that case, in the present replication destination SDS selecting processing, a plurality of volumes 5VαR in a certain storage apparatus 12Rx may be treated as the volumes 5VαR for different storage apparatuses 12Rx located at the identical installation location.

Further, a plurality of volumes 5VαR in a certain storage apparatus 12Rx may be grouped, and a single SDS 2Sy may be assigned to the volumes 5VαR belonging to the identical group. In that case, with information for group management added, in the present replication destination SDS selecting processing, a plurality of groups of volumes 5VαR in a certain storage apparatus 12Rx may be treated as different storage apparatuses 12Rx at the identical installation location.

### (Replication Construction Preparing Processing According to Embodiment 1)

FIG. 18 is a flowchart depicting replication construction preparing processing according to Embodiment 1.

In the present replication construction preparing processing, advance checks and preparations for constructing a replication are performed using the SDS 2Sy selected as the replication destination, and the SDS 2Sy at the replication destination is changed according to the results of the advance checks and preparations.

First, in step S1801, the replication managing program 511 calculates the total required resource amount for the SDS 2Sy selected as the replication destination.

Specifically, the replication managing program 511 calculates the total required resource amount for replication 1205, the total required resource amount for failover 1206, and the worst total required resource amount for failover 1207, including the new DR target volume estimated in step S1603 for the processing for newly registering the DR target volume (FIG. 16).

Here, the total required resource amount for replication 1205 is the total of the required resource amounts for replication 1406 (FIG. 14) for each SDS. Further, the total required resource amount for failover 1206 is the maximum value of the total required resource amount for failover 1407 (FIG. 14) for each SDS 2Sy. This allows a failover that, for example, simultaneously occurs, due to a disaster, in all the storage apparatuses 12Rx in an installation location group with the maximum required resource amount to be dealt with.

Further, the worst total required resource amount for failover 1207 is the total of the total required resource amounts for failover 1407 (FIG. 14) for each SDS 2Sy. The worst total required resource amount for failover 1207 may be calculated in accordance with the operation policy of the DRaaS. For example, even in a case where a failover simultaneously occurs in a predetermined rate of the storage apparatuses 12Rx in a plurality of areas, the clusters of SDSs 2Sy are prevented from reaching an expandible limit scale that could lead to a long-term resource shortage.

Then, in step S1802, the replication managing program 511 determines whether a new SDS 2Sy needs to be constructed. In step S1802, for the total required resource amount (particularly the worst total required resource amount for failover 1207), whether or not a new SDS 2Sy needs to be constructed is determined in reference to whether cluster expansion of SDSs 2Sy allows the total required resource amount calculated in step S1801 to be achieved. In step S1802, instead of whether the total required resource amount is sufficient at present, whether cluster expansion of the SDS 2Sy enables the total required resource amount to be achieved is checked. Note that any other criterion may be used to determine whether to construct a new SDS 2Sy.

The replication managing program 511 shifts the processing to step S1803 in a case where a new SDS 2Sy needs to be constructed (step S1802 YES), and shifts the processing to step S1806 in a case where no new SDS 2Sy needs to be constructed (step S1802 NO).

Then, in step S1803, the replication managing program 511 uses the SDS managing program 512 to construct a new SDS 2Sy. The replication managing program 511 constructs a new SDS 2Sy in a case where the limit at which the SDSs 2Sy can be expanded is reached.

Next, in step S1804, the replication managing program 511 changes the replication destination SDS 2Sy to the new SDS 2Sy created in step S1803.

Then, in step S1805, for the constructed replication for the DR target storage apparatus 12Rx, the replication managing program 511 changes the replication destination SDS 2Sy to the new SDS 2Sy created in step S1803. In step S1805, the replication managing program 511 implements reconfiguration of the storage apparatuses 12Rx and the SDSs 2Sy, migration of data between the SDSs 2Sy, and the like, as needed.

Subsequently, in step S1806, the replication managing program 511 determines whether cluster expansion of the SDS 2Sy is required. The cluster expansion is performed in a case where the total required resource amount for replication 1205 or the total required resource amount for failover 1206 is below the total resource amount for the SDSs 2Sy at present. Note that the cluster expansion is also performed in a case where the storage node performance information 431γy referenced indicates that the total required resource amount for failover 1206 is insufficient. The replication managing program 511 shifts the processing to step S1807 in a case where the cluster expansion of the SDS 2Sy is required (step S1806 YES), and ends the present replication construction preparing processing in a case where no cluster expansion of the SDS 2Sy is required (step S1806 YES).

In step S1807, the replication managing program 511 uses the SDS managing program 512 to implement the cluster expansion of the SDS 2Sy selected as the replication destination. In step S1807, given a worst-case scenario where a failover occurs in all the volumes, the cluster expansion of the SDS 2Sy is performed to enable the total required resource amount in step S1802 (particularly, the worst total required resource amount for failover 1207) to be achieved in a case where a failover occurs in all the volumes. In a case where the total required resource amount fails to be achieved, the replication destination SDS 2Sy is changed to the newly constructed SDS 2Sy.

### (Failover Processing for Defective Volume According to Embodiment 1)

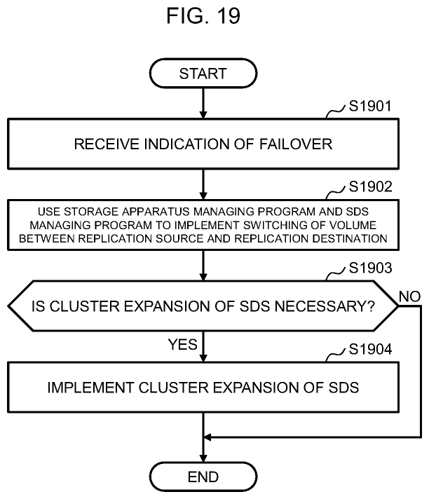

FIG. 19 is a flowchart depicting failover processing executed on a defective volume according to Embodiment 1. The present failover processing is executed by the replication managing program 511 according to an indication from the client under contract for the DRaaS, when the IO processing executed by the storage apparatus 12Rx is failed over to the SDS 2Sy.

First, in step S1901, the replication managing program 511 receives, from the client, an indication to the DR managing system 100 for a failover (including the specification of the target storage apparatus 12Rx and volume 5VαR).

Next, in step S1902, the replication managing program 511 uses the storage apparatus managing program 513 and the SDS managing program 512 to switch the volume between the replication source and the replication destination. In the processing in step S1902, the replication managing program 511 updates, to “Failover,” the replication state 1308 of the replication ID 1301 in the replication management information 113. After the processing in step S1902, the SDS 2Sy takes over the IO processing executed on the volume 5VαR in the storage apparatus 12Rx, and subsequent 10 requests are stored in the volume 1Vβy on the SDS 2Sy side. To reflect the data resulting from the IO in the volume 5VαR on the storage apparatus 12Rx side, volume is switched between the replication source and the replication destination. In a case where a defect has occurred in the storage apparatus 12Rx and is preventing immediate reflection, the reflection occurs during restoration.

Then, in step S1903, the replication managing program 511 determines whether the cluster expansion of the SDS 2Sy is required. In step S1903, whether or not cluster expansion is required is determined, the cluster expansion being performed to secure a predetermined amount of resources for the SDS 2Sy to provide for the next failover. Further, the cluster expansion is also performed in a case where the storage node performance information 431γy referenced indicates that the total required resource amount for failover 1407 is insufficient.

The replication managing program 511 shifts the processing to step S1904 in a case where the cluster expansion of the SDS 2Sy is required (step S1903 YES), and ends the present failover processing in a case where no cluster expansion of the SDS 2Sy is required (step S1903 NO). In step S1904, the replication managing program 511 implements the cluster expansion of the SDS 2Sy.

Information regarding the connection between the application server and the volume 1VβY provided by the SDS 2Sy is registered according to an indication from the client after completion of the switching between the replication source and the replication destination in step S1902 of the present failover processing. Failovers may occur in quick succession, and thus after the fail-over is performed in step S1902, step S1904 is immediately executed to add resources that may become insufficient.

### (Failback Processing for Defective Volume According to Embodiment 1)

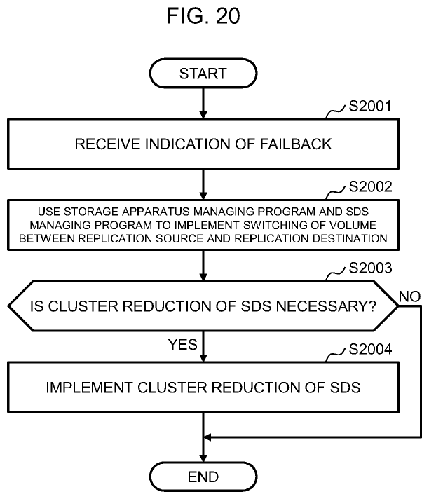

FIG. 20 is a flowchart depicting failback processing for a defective volume according to Embodiment 1. The present failback processing is executed by the replication managing program 511 according to an indication from the client under contract for the DRaaS, when IO processing executed by the SDS 2Sy is failed back to the storage apparatus 12Rx.

First, in step S2001, the replication managing program 511 receives, from the client, an indication to the DR managing system 100 for a failback (including the specification of the target storage apparatus 12Rx and volume 5VαR).

Then, in step S2002, the replication managing program 511 uses the storage apparatus managing program 513 and the SDS managing program 512 to switch the volume between the replication source and the replication destination. In the processing in step S2002, the replication managing program 511 updates, to “Normal,” the replication state 1308 of the replication ID 1301 in the replication management information 113.

Then, in step S2003, the replication managing program 511 determines whether cluster reduction of the SDS 2Sy is required. In step S2003, in a case where failback leads to surplus resources available, and despite reduction of the clusters (reduction in the number of nodes of the SDS 2Sy), the sufficient amount of resources available can be secured in such a manner as to achieve the total required resource amount for failover 1407 for each of the SDS IDs 1402, cluster reduction for the surplus is performed. The cluster reduction for the surplus is performed to reduce the operational cost of the SDS 2Sy.

The replication managing program 511 shifts the processing to step S2004 in a case where the cluster reduction of the SDS 2Sy is required (step S2003 YES), and ends the present failback processing in a case where no cluster reduction of the SDS 2Sy is required (step S2003 NO). In step S2004, the replication managing program 511 performs cluster reduction of the SDS 2Sy.

In Embodiment 1 described above, there is performed multi-tenant operation in which, for every plurality of clients, a failover destination of the storage apparatus 12Rx is distributed among a plurality of SDSs 2Sy, which are shared by the plurality of clients. Thus, the plurality of clients can share the maximum required amount of surplus resources for the SDS 2Sy that are secured at normal times to provide for a failover. This enables a reduction in surplus computational resources and in the operational cost of the DRaaS.

Further, backup destination SDSs 2Sy are selected in such a manner as to be distributed across the installation locations (areas) of the storage apparatuses 12Rx. Although the backup destination SDSs 2Sy may be dynamically determined, there is constructed in advance mapping in which elements belonging to a predetermined group such as a consistency group are not distributed and are failed over to an identical SDS 2Sy. This allows a quick failover to be achieved while the operational cost of the DRaaS is reduced.

### Embodiment 2

In Embodiment 1, the DR destination SDS 2Sy of the storage apparatus 12Rx is assumed to be present on a public cloud (or a private cloud) managed by the DRaaS provider. However, the area in which the public cloud is installed may be affected by a disaster, and the public cloud may become unavailable.

Accordingly, in Embodiment 2, given the possibility of the DR destination SDS 2Sy itself being affected by a disaster, there is used a configuration in which the public cloud (or the private cloud) on which the SDSs 2Sy are installed is present in a plurality of areas (for example, regions). In Embodiment 2, when an SDS 2Sy is newly constructed, the SDS 2Sy is constructed on a specified public cloud.

In the description of Embodiment 2, differences from Embodiment 1 will be focused on.

### (Configuration of Information Processing System 2S According to Embodiment 2)

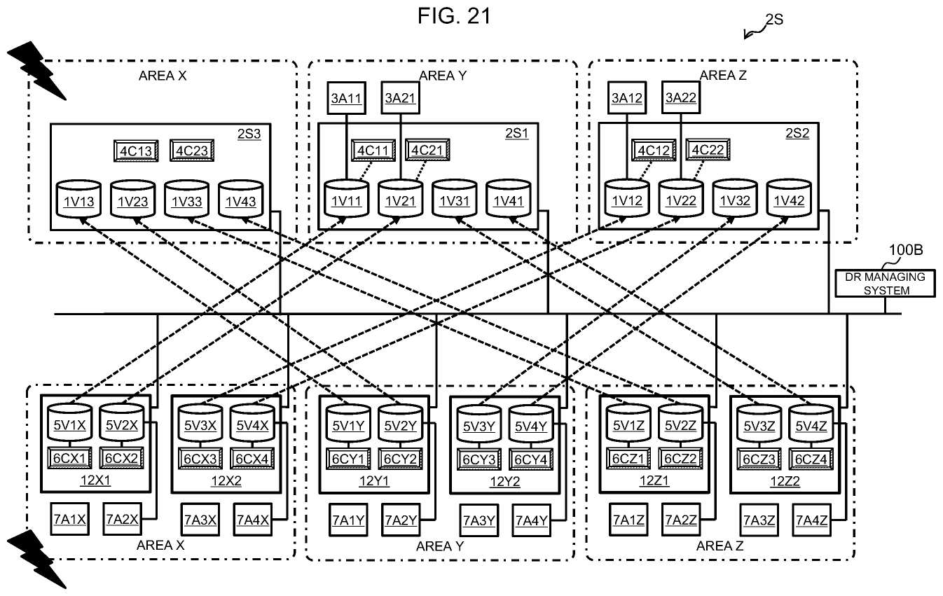

FIG. 21 is a diagram depicting a configuration of an information processing system 2S according to Embodiment 2.

The information processing system 2S includes storage apparatuses 12Rx (12X1, 12X2, 12Y1, 12Y2, 12Z1, and 12Z2), SDSs 2Sy (2S1, 2S2, and 2S3), and a DR managing system 100B. The SDSs 2Sy and the DR managing system 100B constitute a DR system constructed on the cloud by the provider of the DRaaS.

In the information processing system 2S, a plurality of storage apparatuses 12Rx of a plurality of clients are located in remote areas X, Y, and Z that would not be simultaneously affected by a disaster. Compared to the information processing system 1S in Embodiment 1, the information processing system 2S further includes the storage apparatuses 12Z1 and 12Z2 operated by a client-managed data center in the area Z.

Further, in the information processing system 2S, a plurality of SDSs 2Sy are located in each of the areas X, Y, and Z. The SDS 2S1 is operated by the data center in the area Y. The SDS 2S2 is operated by the data center in the area Z. The SDS 2S3 is operated by the data center in the area X.

In the information processing system 2S, data stored in each of the volumes 5VαR (5V1X, 5V2X, 5V3X, 5V4X, 5V1Y, 5V2Y, 5V3Y, 5V4Y, 5V1Z, 5V2Z, 5V3Z, and 5V4Z) for the client-managed storage apparatuses 12Rx is replicated (duplicated) in advance in any of the SDSs 2Sy.

In the information processing system 2S, when a defect occurs in any of the storage apparatuses 12Rx, the volume 1Vβy (1V11, 1V21, 1V31, or 1V41) in any of the replication destination SDSs 2Sy takes over (fails over) IO processing executed on the volume 5VαR.

The storage apparatus 12Z1 includes CPUs 6CZ1 and 6CZ2 and volumes 5V1Z and 5V2Z on which the CPUs 6CZ1 and 6CZ2 process IO from applications 7A1Z and 7A2Z. Similarly, the storage apparatus 12Z2 includes CPUs 6CZ3 and 6CZ4 and volumes 5V3Z and 5V4Z on which the CPUs 6CZ3 and 6CZ4 process IO from applications 7A3Z and 7A4Z.

The SDSs 2S1 and 2S2 constitute an SDS cluster on the cloud. The SDSs 2S1 and 2S2 are connected via a network 250 to the storage apparatuses 12X1, 12X2, 12 Y1, and 12Y2 to constitute a DR system for the storage apparatuses 12X1, 12X2, 12 Y1, and 12Y2.

The SDS 2S3 includes CPUs 4C13 and 4C23 and volumes 1V13, 1V23, 1V33, and 1V43 on which the CPUs 4C13 and 4C23 execute IO processing.

The SDS 2S1 includes a required number of CPUs 4C11 and 4C21 that can execute IO processing for any of the volumes 5V1X and 5V2X in the area X that may be failed over to the SDS 2S1 at once due to a disaster or the volumes 5V3Z and 5V4Z in the area Z that may be failed over to the SDS 2S1 at once due to a disaster. Similarly, the SDS 2S2 includes a required number of CPUs 4C12 and 4C22 that can execute IO processing for any of the volumes 5V3X and 5V4X in the area X that may be failed over to the SDS 2S2 at once due to a disaster or the volumes 5V3Y and 5V4Y in the area Y that may be failed over to the SDS 2S2 at once due to a disaster. Similarly, the SDS 2S3 includes a required number of CPUs 4C13 and 4C23 that can execute IO processing for any of the volumes 5V1Y and 5V2Y in the area Y that may be failed over to the SDS 2S3 at once due to a disaster or the volumes 5V1Z and 5V2Z in the area Z that may be failed over to the SDS 2S3 at once due to a disaster.

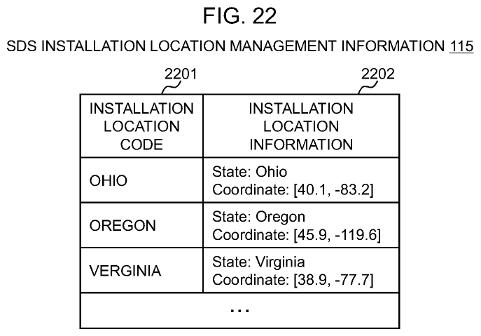

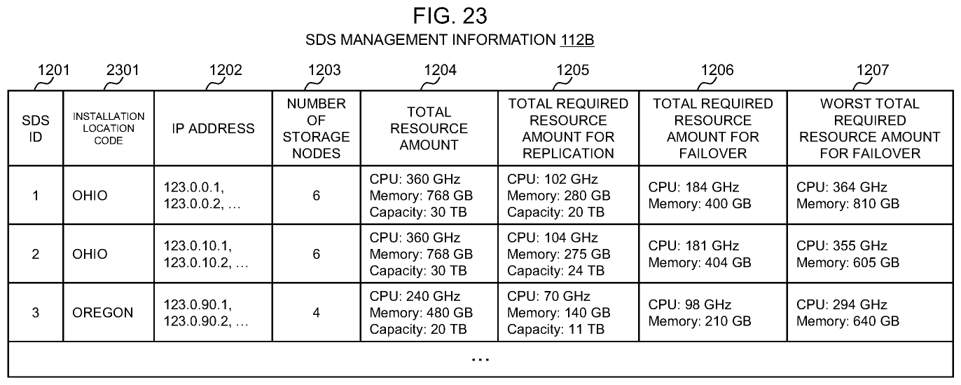

Compared to the DR managing system 100 in Embodiment 1, the DR managing system 100B further includes, in the memory 13, SDS installation location management information 115 (FIG. 22) as the DR management information 52, and SDS management information 112B (FIG. 23) instead of the SDS management information 112.

As described above, with the DR destination SDSs 2Sy distributed with respect to the installation location of the storage apparatus 12Rx, the SDS 2Sy in an area different from the area where the storage apparatus 12Rx is installed is selected as the DR destination SDS 2Sy.

In the example in FIG. 21, when a disaster occurs in the area X, the volumes 1V11 and 1V21 in the SDS 2S1 process IO from the applications 3A11 and 3A21 to take over the IO processing executed by the applications 7A1X and 7A2X on the volumes 5V1X and 5V2X. Further, when a disaster occurs in the area X, the volumes 1V21 and 1V22 in the SDS 2S2 process IO from the applications 3A21 and 3A22 to take over the IO processing executed by the applications 7A3X and 7A4X on the volumes 5V3X and 5V4X.

Note that a plurality of SDSs 2Sy may be located in areas X1, Y1, and Z1 among areas X, Y, Z, X1, Y1, and Z1 that are remote from one another and would not be simultaneously affected by a disaster. Note that at least one of the area X1=area X, the area Y1=area Y, and the area Z1=area Z may be established.

### (SDS Installation Location Management Information 115 According to Embodiment 2)

FIG. 22 is a diagram depicting SDS installation location management information 115 according to Embodiment 2. The SDS installation location management information 115 is information used to manage the installation location of the SDS 2Sy (public cloud that is a platform constructing the SDS 2Sy). The SDS installation location management information 115 is information registered by the DRaaS provider in advance.

The SDS installation location management information 115, for example, manages an installation location code 2201 in association with installation location information 2202 including a location name and coordinate information. The SDS installation location management information 115 may include authentication information for using the public cloud, and the like.

When newly constructing an SDS 2Sy, the SDS managing program 512 receives the installation location code 2201 and constructs an SDS on the public could (or a private cloud) corresponding to the installation location code 2201.

### (SDS Management Information 112B According to Embodiment 2)

FIG. 23 is a diagram depicting SDS management information 112B according to Embodiment 2. The SDS management information 112B includes information of an installation location code 2301 indicating the installation location of the SDS, in addition to the SDS management information 112 (FIG. 12) in Embodiment 1.

### (Replication Destination SDS Selecting Processing According to Embodiment 2)

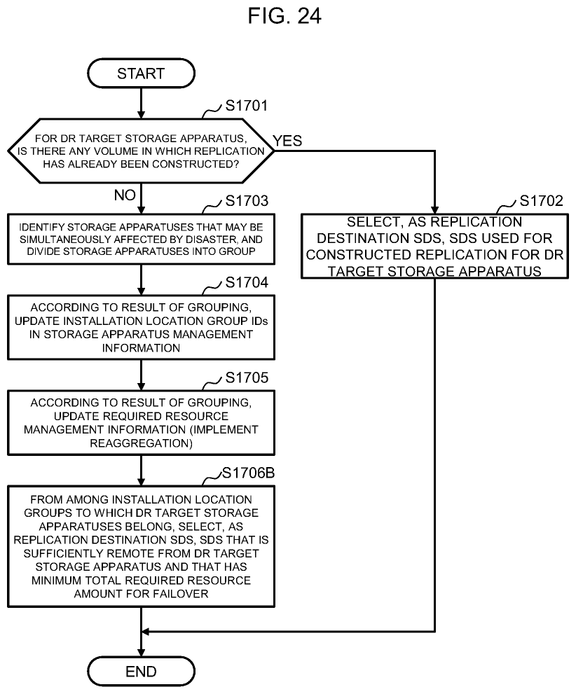

FIG. 24 is a flowchart depicting replication destination SDS selecting processing according to Embodiment 2. In Embodiment 2, in the processing for newly registering the DR target volume (FIG. 16), replication destination SDS selecting processing according to Embodiment 2 is executed in place of the replication destination SDS selecting processing according to Embodiment 1 (FIG. 17). Further, in the replication construction preparing processing according to Embodiment 1 (FIG. 18), when a new SDS 2Sy is constructed, the SDS 2Sy needs to be selected using the same installation location code as that of an originally selected SDS 2Sy.

When the replication destination SDS selecting processing according to Embodiment 2 is compared with the replication destination SDS selecting processing according to Embodiment 1 (FIG. 17), these processing operations are similar except that, in the processing in Embodiment 2, step S1706B is executed in place of step S1706.

In step S1706B, the replication managing program 511 selects, as the replication destination SDS 2S1, the SDS 2S1 in the installation location group to which the DR target storage apparatus 12Rx belongs (installation location group ID 1401), the SDS 2S1 being so remote from the DR target storage apparatus 12Rx that the SDS 2S1 would not be simultaneously affected by a disaster and having the minimum total required resource amount for failover 1407. That is, the SDS 2S1 located in the vicinity of the installation location group of the DR target storage apparatus 12Rx is excluded from the selection target.

### Other Embodiments

In the above-described embodiments, the duplicate volumes of the volumes for the storage apparatus 12Rx are located in a distributed manner in a plurality of SDSs 2Sy. However, the targets to be located in a distributed manner are not limited to the duplicate volumes. That is, the DR managing systems 100 and 100B may select pieces of equipment including a controller and a communication port for the backup destination SDS 2Sy in which the duplicate volumes are located, in such a manner that the pieces of equipment are located in a distributed manner with respect to the installation location on a per-volume 5VαR basis of the storage apparatus 12Rx.

The present invention is not limited to the above-described embodiments and includes many variations. For example, the above-described embodiments have been described in detail in order to describe the present invention in an easy-to-understand manner, and are not necessarily limited to embodiments including all the configurations described. Further, as long as there is no inconsistency, a part of one of the embodiments can be replaced with another embodiment, and the configuration of one embodiment can be provided with the configuration of another embodiment. Further, addition, removal, replacement, integration, or distribution of the configuration can be applied to a part of the configuration of each embodiment. In addition, the configurations and processing operations disclosed in the embodiments can be distributed, integrated, or replaced as appropriate according to processing efficiency or implementation efficiency.

What is claimed is:

1. An information processing system comprising:
a plurality of storage apparatuses installed in a plurality of areas;
a plurality of storage systems including a plurality of storage nodes provided on a cloud; and
a management system, wherein
a processor of the management system
acquires, from each of the plurality of storage apparatuses, configuration information and performance information regarding volumes of the plurality of storage apparatuses,
estimates, in reference to the configuration information and the performance information, a required resource amount for replication in a corresponding one of the storage systems that is required when a duplicate volume to which a volume of each of the plurality of storage apparatuses is to be failed over is created in the storage system and a required resource amount for failover in the storage system that is required when the volume is failed over to the duplicate volume,
divides, according to an installation location, the plurality of storage apparatuses into installation location groups of the storage apparatuses, the storage apparatuses possibly simultaneously becoming defective,
aggregates, for each of the installation location groups and for each of the storage systems, the required resource amount for replication and the required resource amount for failover related to the volume of each of the storage apparatuses,
selects, as the storage system of a replication destination in which the duplicate volume is to be created, the storage system in such a manner as to minimize the required resource amount for failover aggregated for each of the installation location groups and for each of the storage systems, while locating in a distributed manner, in the plurality of storage systems, the duplicate volume related to the plurality of storage apparatuses located at an identical point, and
implements, on the selected storage system of the replication destination, replication in which the duplicate volume is created.

2. The information processing system according to claim 1, wherein
the processor
estimates, for the required resource amount for replication, a required resource amount for a processor, a memory, and a storage capacity of the storage system, and
estimates, for the required resource amount for failover, a required resource amount for a processor and a memory of the storage system.

3. The information processing system according to claim 1, wherein
the processor
calculates a total required resource amount based on the required resource amount for replication and the required resource amount for failover in the storage system of the replication destination,
determines whether the storage system of the replication destination is able to achieve the total required resource amount, and
implements cluster expansion of the storage system in a case where the storage system of the replication destination is determined to be unable to achieve the total required resource amount.

4. The information processing system according to claim 3, wherein
the processor
newly constructs the storage system in a case where the processor determines that the total required resource amount fails to be achieved even when the storage system of the replication destination implements the cluster expansion, and
changes the storage system to the new storage system as the storage system of the replication destination.

5. The information processing system according to claim 1, wherein
the processor
determines whether a resource amount available for the storage system needs to be secured when the volume of the storage apparatus is failed over, and
implements cluster expansion of the storage system in a case where the processor determines that the resource amount needs to be secured.

6. The information processing system according to claim 5, wherein
the processor
determines whether the required resource amount for failover is secured even in a case where cluster reduction of the storage system is implemented when the volume of the storage apparatus is failed back, and
implements the cluster reduction of the storage system in a case where the processor determines that the required resource amount for failover is secured.

7. The information processing system according to claim 1, wherein
the processor
constructs, in the identical storage system, the duplicate volumes of a plurality of the volumes of a corresponding one of the storage apparatuses.

8. The information processing system according to claim 1, wherein
the processor
constructs, in a plurality of the storage systems, the duplicate volumes of a plurality of the volumes of a corresponding one of the storage apparatuses.

9. The information processing system according to claim 1, wherein
the processor
selects equipment including a controller and a communication port related to the storage system of the replication destination in which the duplicate volumes are created, in such a manner that the equipment is located in a distributed manner with respect to the volumes.

10. The information processing system according to claim 1, wherein
the plurality of storage systems are installed in the plurality of areas, and
the processor
selects the storage system of the replication destination in such a manner that a plurality of the duplicate volumes related to the plurality of storage apparatuses located at the identical point are located in a distributed manner in the plurality of storage systems located at a point different from the identical point.

11. An information processing method performed in an information processing system including a plurality of storage apparatuses installed in a plurality of areas, a plurality of storage systems including a plurality of storage nodes provided on a cloud, and a management system, the method comprising:
by a processor of the management system
acquiring, from each of the plurality of storage apparatuses, configuration information and performance information regarding volumes of the plurality of storage apparatuses;
estimating, in reference to the configuration information and the performance information, a required resource amount for replication in a corresponding one of the storage systems that is required when a duplicate volume to which a volume of each of the plurality of storage apparatuses is to be failed over is created in the storage system and a required resource amount for failover in the storage system that is required when the volume is failed over to the duplicate volume;
dividing, according to an installation location, the plurality of storage apparatuses into installation location groups of the storage apparatuses, the storage apparatuses possibly simultaneously becoming defective;
aggregating, for each of the installation location groups and for each of the storage systems, the required resource amount for replication and the required resource amount for failover related to the volume of each of the storage apparatuses;
selecting, as the storage system of a replication destination in which the duplicate volume is created, the storage system in such a manner as to minimize the required resource amount for failover aggregated for each of the installation location groups and for each of the storage systems, while locating in a distributed manner, in the plurality of storage systems, the duplicate volume related to the plurality of storage apparatuses located at an identical point; and
implementing, on the selected storage system of the replication destination, replication in which the duplicate volume is created.
